(19) United States
(12) Patent Application Publication
(10) Pub. No.: US 2016/0117102 A1
(43) Pub. Date: Apr. 28, 2016

(54) METHOD FOR OPERATING DATA STORAGE DEVICE, MOBILE COMPUTING DEVICE HAVING THE SAME, AND METHOD OF THE MOBILE COMPUTING DEVICE

(71) Applicants: Seong Cheol HONG, Hwaseong-si (KR); Seung Uk SHIN, Seoul (KR); Sang Won JUNG, Busan (KR); Jeong Hoon CHO, Hwaseong-si (KR); Kyung Ho KIM, Seoul (KR); Hong Suk CHOI, Hwaseong-si (KR)

(72) Inventors: Seong Cheol HONG, Hwaseong-si (KR); Seung Uk SHIN, Seoul (KR); Sang Won JUNG, Busan (KR); Jeong Hoon CHO, Hwaseong-si (KR); Kyung Ho KIM, Seoul (KR); Hong Suk CHOI, Hwaseong-si (KR)

(21) Appl. No.: 14/921,213

(22) Filed: Oct. 23, 2015

(30) Foreign Application Priority Data
Oct. 27, 2014 (KR) 10-2014-0145651

(51) Int. Cl. G06F 3/06; G06F 12/02

(52) U.S. Cl. CPC G06F 3/061; G06F 3/0688; G06F 3/0659; G06F 12/0253; G06F 12/0246; G06F 2212/7205; G06F 2212/7201

(57) ABSTRACT

A method for operating a data storage device includes receiving a command including a set bit transmitted from a host, storing the set bit in a register in response to the command, receiving a first state check command from the host, and transmitting a response which includes state information of the data storage device and processing information corresponding to a write command in the data storage device to the host based on the first state check command and the set bit stored in the register.

### CROSS-REFERENCE TO RELATED APPLICATION

This application claims priority under 35 U.S.C. §119(a) from Korean Patent Application No. 10-2014-0145651 filed on Oct. 27, 2014, the disclosure of which is incorporated herein by reference in its entirety.

### BACKGROUND

1. Field

At least some example embodiments of the inventive concepts relate to a data storage device, and particularly to a data storage device capable of transmitting information on processing time for a write command to a host, a method for operating the data storage device, and a mobile computing device capable of adjusting read latency based on the information.

2. Related Art

Unlike a dynamic random access memory (DRAM) or a hard disk drive (HDD), a flash memory may not perform an in-place update operation on data. After a program code is written in a NOR flash memory, an update is hardly generated in the NOR flash memory. However, since an update on data is frequently generated in a NAND flash memory, an erase operation for an update is needed.

In the NAND flash memory, in order to update data written in a memory region, an erase operation to erase the data written in the memory region needs to be performed. The erase operation may take longer than a write operation (or a program operation) or a read operation, and a size of a memory region or data which is subjected to the erase operation may be larger than a size of a memory region or data which is subjected to the write operation or the read operation. In general, the write operation or the read operation is performed on a page basis, and the erase operation is performed on a block basis. At this time, one block includes a plurality of pages.

When an update request for a page or page data written in a first memory region of a flash memory occurs, the flash memory, without immediately deleting the page, writes a page to be updated in a second memory region of the flash memory, and then makes the page written in the first memory region invalid and remaps the page to be updated using a mapping table.

When the number of invalid pages is increased in the flash memory, a memory region or a free block to write new pages in becomes insufficient. Accordingly, the flash memory periodically performs an erase operation on the block. At this time, the flash memory performs an operation of copying valid pages stored in a corresponding block to another memory region before performing an erase operation on the corresponding block. This is referred to as garbage collection.

### SUMMARY

A technical object of at least one example embodiment of the inventive concepts is to provide a host capable of transmitting a command requiring whether or not a background operation is performed so as to adaptively adjust read latency to a data storage device and a method for operating the host.

A technical object of at least one example embodiment of the inventive concepts is to provide a data storage device capable of transmitting a response which represents whether or not a background operation is performed to a host in response to a command requiring whether or not the background operation is performed, and a method for operating the data storage device. The data storage device includes a three dimensional memory array, wherein the three-dimensional memory array comprises a non-volatile memory that is monolithically formed in one or more physical levels of memory cells having active areas disposed above a silicon substrate.

A technical object of at least one example embodiment of the inventive concepts is to provide a mobile computing device which includes a host capable of transmitting a command requiring whether or not a background operation is performed to a data storage device so as to adaptively adjust read latency, and the data storage device capable of transmitting a response that represents whether or not the background operation is performed to the host, and a method for operating the mobile computing device.

According to at least one example embodiment of the inventive concepts, a method for operating a data storage device includes receiving a first command including a set bit transmitted from a host; storing the set bit in a register in response to the first command; receiving a first state check command from the host; and transmitting a response which includes state information of the data storage device and processing information corresponding to a write command for the data storage device to the host based on the first state check command and the set bit stored in the register.

The method may further include generating, by the data storage device, the response such that the processing information includes information on latency of a write command to be processed in the data storage device.

The method may further include generating, by the data storage device, the response such that the processing information includes information on garbage collection which is being performed in the data storage device.

The method may further include receiving a read command from the host while the garbage collection is performed; stopping the garbage collection in response to the read command; transmitting read data to the host in response to the read command; and resuming the stopped garbage collection.

The method may further include transmitting a response which indicates a completion of the garbage collection to the host in response to a second state check command transmitted from the host after the garbage collection is completed; and receiving a write command and write data from the host and storing the write data in a memory based on the write command.

The method may further include, when the garbage collection is performed in a plurality of steps, and the plurality of steps have different execution times, the data storage device generating the response such that the response includes the processing information including bits corresponding to each of the plurality of steps.

The data storage device may be an embedded multimedia card (eMMC), the first command may be a SWITCH command (CMD6) including the set bit, the register may be an EXT_CSD register, the storing the set bit may include storing the set bit in a vender specific field of the EXT_CSD register, and the first state check command is CMD13.

According to at least one example embodiment of the inventive concepts, a method for operating a mobile computing device including a host and a data storage device includes determining, by the host, read latency of a read command to be performed in the data storage device; transmitting, by the host, a first command to the data storage device according to a result of the determination, the first command including a set bit; storing, by the data storage device, the set bit in a register in response to the first command; transmitting, by the host, a first state check command to the data storage device; and transmitting, by the data storage device, one of a first response and a second response to the host based on the first state check command and the set bit stored in the register.

The method may further include generating the first response such that the first response includes state information of the data storage device, and generating the second response such that the second response includes the state information of the data storage device and processing information corresponding to a write command for the data storage device.

The method may further include rescheduling, by the host, at least one of a read command and a write command to be transmitted to the data storage device based on the second response.

The method may further include adjusting, by the host, a transmission interval of a queue ready check command to be transmitted to the data storage device based on the second response.

The method may further include generating the processing information such that the processing information includes at least one of information on latency of a next write command to be processed in the data storage device and information indicating a background operation which is being performed in the data storage device.

The background operation may include at least one of garbage collection, wear leveling, and a read reclaim operation.

The method may further include receiving, by the data storage device, a first read command from the host while the garbage collection is being performed; stopping, by the data storage device, the garbage collection in response to the first read command; transmitting, by the data storage device, read data to the host in response to the first read command; and resuming, by the data storage device, the stopped garbage collection.

The method may further include transmitting, by the data storage device to the host, a third response which indicates a completion of the garbage collection, in response to a second state check command, the second state check command being a command transmitted from the host after the garbage collection is completed; and receiving, by the data storage device, a first write command and write data from the host, and storing the write data in a memory based on the first write command.

The data storage device may be an embedded multimedia card (eMMC), the first command is a SWITCH command (CMD6) including the set bit, the register is an EXT_CSD register, the storing the set bit includes storing the set bit in a vender specific field of the EXT_CSD register, and the first state check command is CMD13.

According to at least one example embodiment of the inventive concepts, a method for operating a host includes determining, at the host, a read latency of a data storage device; generating, at the host, a set indicator such that a value of the set indicator is selected by the host based on the determined read latency; transmitting a state check command from the host to the data storage device; receiving, at the host, a first response from the data storage device, a response type of the first response being a first type or a second type; when the first response indicates that the data storage device is performing a background operation, determining whether or not to rearrange an order of data access commands in a command schedule of the host based on the response type of the first response; and sending a first data access command from the host to the data storage device based on the command schedule.

The determining whether or not to rearrange the order data access commands may include, when the response type of the first response is the second type, rearranging the order of the data access commands in a command schedule of the host such that a read command in the command schedule is moved in from of a write command in the command schedule, and when the response type of the first response is the first type, maintaining a current order of the command schedule without rearranging the command schedule.

The generating the set indicator may include generating the set indicator to have a first value when the determined latency is above a reference value and generating the set indicator to have a second value when the determined latency is not above the reference value.

The receiving the first response from the data storage device may include receiving the first response having the second response type when the set indicator has the first value and receiving the first response having the first response type when the set indicator has the second value.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a schematic block diagram of a data processing system according to an at least one example embodiment of the inventive concepts;

FIG. 2 is a data flowchart which describes a scheduling operation of an input/output scheduler performed in the data processing system shown in FIG. 1 according to at least one example embodiment of the inventive concepts;

FIG. 3 is a drawing which describes an operation of the data processing system shown in FIG. 1 according to at least one example embodiment of the inventive concepts;

FIG. 4 is a drawing of the operation of the data processing system shown in FIG. 1 according to at least one example embodiment of the inventive concepts;

FIG. 5 is a data flowchart which describes a the operation of the data processing system shown in FIG. 1 according to at least one example embodiment of the inventive concepts;

FIG. 6 is a conceptual diagram which describes a method of adjusting a transmission interval of a queue ready check command according to according to at least one example embodiment of the inventive concepts; and

FIG. 7 is a block diagram of a system which includes the data processing system shown in FIG. 1.

### DETAILED DESCRIPTION OF THE EMBODIMENTS

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

As is discussed above, a flash memory performs an operation of copying valid pages stored in a corresponding block to another memory region before performing an erase operation on the corresponding block. This is referred to as garbage collection. In the flash memory, when the garbage collection is performed while a write operation is performed according to a write command, response time for the write command is extended. That is, the flash memory writes write data corresponding to a write command in a memory region after a completion of the garbage collection, and transmits a write completion response to a host after a completion of a write operation. Even if the host intends to perform a read operation on a flash memory, the host may not perform the read operation on the flash memory until the host receives a write completion response. Accordingly, read latency for a read operation is increased.

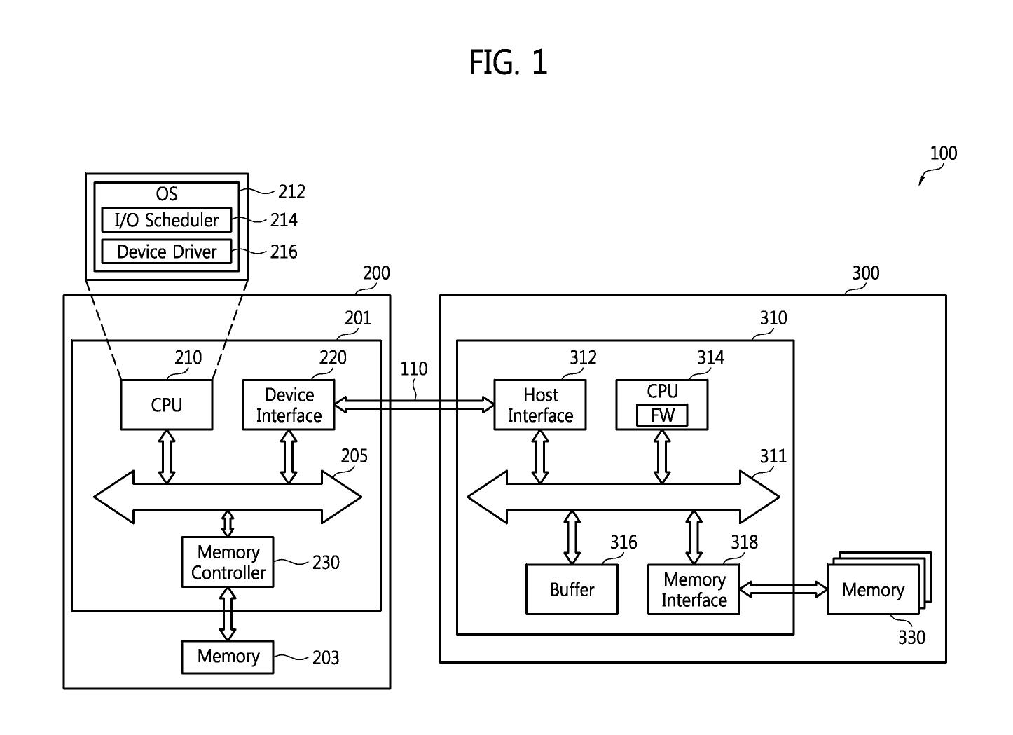

FIG. 1 is a schematic block diagram of a data processing system according to at least one example embodiment of the inventive concepts. Referring to FIG. 1, a data processing system 100 includes a host 200 and a data storage device 300 which are connected to each other through an interface 110. The data processing system 100 may be embodied as a personal computer (PC), a desktop computer, a laptop computer, a workstation computer, or a mobile computing device.

The mobile computing device may be embodied in a mobile phone, a smart phone, a tablet PC, a personal digital assistant (PDA), an enterprise digital assistant (EDA), a digital still camera, a digital video camera, a portable multimedia player (PMP), a multimedia device, a personal navigation device or portable navigation device (PND), a handheld game console, a mobile internet device (MID), a wearable device (or wearable computer), an internet of things (IoT) device, an internet of everything (IoE) device, or an e-book.

The host 200 may include a processing circuit 201 and a first memory 203. The processing circuit may be, or include, a processor. The term ‘processor’, as used herein, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multiprocessor, an application-specific integrated circuit (ASIC), and a field programmable gate array (FPGA).

The host 200 may be embodied as an integrated circuit (IC), an application processor (AP), a mobile AP, or a system on chip (SoC); however, the host is not limited thereto. According to at least some example embodiments of the inventive concepts, the host 200 may be embodied as a package on package (PoP), a system on package (SoP), or a system in package (SiP); however, the host is not limited thereto.

When a first package includes the processing circuit 201 embodied as an IC, an AP, a mobile AP, or SoC, and a second package includes the memory (or memory chip) 203, the processing circuit 201 may be attached to a printed circuit board (PCB) in a flip-chip structure, or may be connected to the PCB through bonding wires. The second package may be stacked over the first package through stack balls attached to the PCB.

The processing circuit 201 may include a first CPU 210, a device interface 220, and a memory controller 230. According to at least one example embodiment of the inventive concepts, the processing circuit 201 may be a chip or a die.

The first CPU 210, the device interface 220, and the memory controller 230 may transmit or receive data through a bus architecture 205. The bus architecture 205 may support an Advanced Microcontroller Bus Architecture (AMBA) bus protocol, an advanced high-performance bus (AHB) protocol, an advanced peripheral bus (APB) protocol, or an advanced eXtensible interface (AXI) bus protocol; however, the bus architecture is not limited thereto.

The first CPU 210 may implement an operating system (OS) 212 and firmware (e.g., including one or more programs) performing operations to be described in the present specification. For example, the OS 212 and firmware implemented by the first CPU 210 may be defined by instructions which may be stored, for example, in the first memory 203 and executed by the first CPU 210. According to at least one example embodiment of the inventive concepts, operations described in the present specification as being performed by the OS 212 or firmware may be performed by the first CPU 210 executing the instructions defining the OS 212 and/or firmware. The OS 212 executed by the first CPU 210 may include an input/output scheduler 214 and a device driver 216. While FIG. 1 illustrates an example in which the OS 212 includes the input/output scheduler 214 and the device driver 216, according to at least one example embodiment of the inventive concepts, the OS 212 may not include one or both of the input/output scheduler 214 and the device driver 216, and the OS 212 may control the input/output scheduler 214 and the device driver 216 even when not including the input/output scheduler 214 and the device driver 216. Instructions (e.g., code) defining the OS 212 or the firmware may be loaded to the first CPU 210 from the first memory 203 to be executed. The first CPU 210 may include one or more cores.

The device interface 220 may transmit or receive data or signals to or from a data storage device 300 according to a control of the first CPU 210.

The memory controller 230 may write data in the first memory 203 or read data from the first memory 203 according to a control of the first CPU 210. According to at least one example embodiment of the inventive concepts, the memory controller 230 may perform a function of a direct access memory (DMA) controller.

The first memory 203 may be embodied as a volatile memory and/or a non-volatile memory. The volatile memory may be embodied as a random access memory (RAM), a dynamic RAM (DRAM), or a static RAM (SRAM). The non-volatile memory may be embodied as an electrically erasable programmable read-only memory (EEPROM), a flash memory, a magnetic RAM (MRAM), a spin-transfer torque MRAM, a ferroelectric RAM (FeRAM), a phase change RAM (PRAM), or a resistive RAM.

For example, the first memory 203 may be embodied as a hard disk drive (HDD), a smart card, a secure digital (SD) card, a multimedia card (MMC), an embedded MMC (eMMC), an embedded multi-chip package (eMCP), a perfect page NAND (PPN), a universal flash storage (UFS), a solid state drive (SSD), or an embedded SSD (eSSD). Moreover, the first memory 203 may be embodied as a fixed memory or a removable memory.

For convenience of description in FIG. 1, one first memory 203 and one memory controller 230 are shown; however, the first memory 203 may be a plurality of memories, and the memory controller 230 may be a plurality of memory controllers corresponding to the plurality of memories. The plurality of memories may include different types of memories.

The data storage device 300 may include a controller 310 and at least one second memory 330. For example, the data storage device 300 is a three dimensional non-volatile memory device. The data storage device 300 may store data output from the host 200. The data storage device 300 may be embodied as a smart card, a secure digital (SD) card, a multimedia card (MMC), an embedded MMC (eMMC), an embedded multi-chip package (eMCP), a perfect page NAND (PPN), a universal flash storage (UFS), a USB flash drive, a solid state drive (SSD), or an embedded SSD (eSSD).

The controller 310 may control data transmitting or receiving between the host 200 and the at least one second memory 330. The controller 310 may include a host interface 312, a second CPU 314, a buffer 316, and a memory interface 318.

The host interface 312, the second CPU 314, the buffer 316, and the memory interface 318 may transmit or receive data or signals to or from each other through a bus architecture 311. According to at least some example embodiments of the inventive concepts, each of the interfaces 110, 220, and 312 may be embodied as an interface which can support a peripheral component interconnect express (PCIe) protocol, an interface which can support a serial advanced technology attachment (SATA) protocol, or an interface which can support a serial attached small computer system interface (SCSI) protocol; however, the interfaces 110, 220, and 312 are not limited to the example protocols described above.

The second CPU 314 may execute firmware or a computer program which can control an operation of the data storage device 300. Although one second CPU 314 is shown in FIG. 1; however, the controller 310 may include a one CPU which processes a command and/or data output from the host 200 and another CPU which controls an access operation, e.g., a write operation, a read operation, and/or an erase operation, in the second memory 330 according to at least one example embodiment of the inventive concepts.

The buffer 316 may buffer data transmitted or received between the host 200 and the second memory 330. For example, the buffer 316 may be embodied in a SRAM.

The memory interface 318 may perform a function of a memory controller. Accordingly, the memory interface 318 may control the access operation, e.g., a write operation, a read operation, and/or an erase operation, in the second memory 330 according to a control of the second CPU 314 or a control of the firmware FW, which may be implemented by the second CPU 314. For example, instructions defining the firmware FW may be stored in the second memory 330 and executed by the second CPU 314, and all operations described being performed by the firmware FW of the data storage device 300 may be performed by the second CPU 314 executing the instructions defining the firmware FW. The second memory 330 includes a two dimensional (2D) memory array or a three dimensional (3D) memory array. The 2D or 3D memory array includes a plurality of blocks. Each of the plurality of blocks includes a plurality of pages. Each of the plurality of pages includes a plurality of memory cells. Each of the memory cells may be a single level cell (SLC) that store information of one bit or a multi-level cell (MLC) that stores information of at least two bits. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array. In an embodiment of the present inventive concept, the 3D memory array includes vertical NAND strings that are vertically oriented such that at least one memory cell is located over another memory cell. The at least one memory cell may comprise a charge trap layer. The following patent documents, which are hereby incorporated by reference, describe suitable configurations for three-dimensional memory arrays, in which the three-dimensional memory array is configured as a plurality of levels, with word lines and/or bit lines shared between levels: U.S. Pat. Nos. 7,679,133; 8,553,466; 8,654,587; 8,559,235; and US Pat. Pub. No. 2011/0233648.

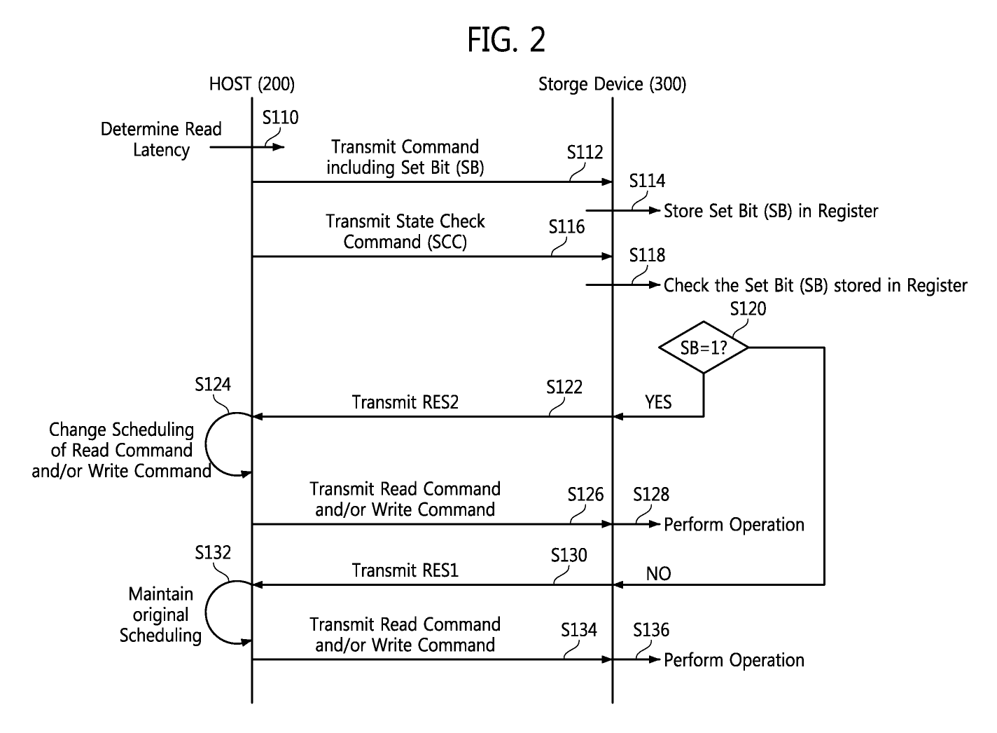

An operation of the input/output scheduler 214 implemented by the first CPU 210 of the host 200 and an operation of the firmware FW implemented by the second CPU 314 of the data storage device 300 will be described in detail referring to FIGS. 2 to 6.

The input/output scheduler 214 implemented by the first CPU 210 may determine when to issue an input/output command, e.g., a read command and a write command, to the data storage device 300 based on a second response transmitted from the data storage device 300.

Moreover, the input/output scheduler 214 may change an issue sequence of originally scheduled commands based on a second response transmitted from the data storage device 300. In addition, the input/output scheduler 214 may adjust a transmission interval or a polling interval of originally scheduled queue ready check commands based on the second response transmitted from the data storage device 300.

FIG. 2 is a data flowchart which describes a scheduling operation of an input/output scheduler executed in the data processing system shown in FIG. 1 according to at least one example embodiment of the inventive concepts. When the data storage device 300 transfers a response including information identifying a time for processing a write command to the host 200, the host 200 may change a schedule for a read command based on the response. Accordingly, the host 200 may use the response to reduce read latency.

Referring to FIGS. 1 and 2, the first CPU 210 of the host 200 may determine a read latency in step S110. Further, in step S110 the first CPU 210 may determine whether or not the read latency is important or needs to be improved. For example, in step S110 the first CPU 210 may determine a time point when the read latency is determined to be important or a time point when read performance is determined to need improving. The determination may be performed by the firmware or the input/output scheduler 214 implemented by the first CPU 210.

In step S112 the first CPU 210 transfers a command including a set bit SB based on the determination in step S110. When the first CPU 210 determines, in step S110, that the read latency is important or needs to be improved, in step S112 the first CPU 210 of the host 200 may transfer a command including a set bit SB having a first value, e.g., a high level or logic 1, to the second CPU 314 of the data storage device 300 through components 205, 220, 110, 312, and 311. However, when the first CPU 210 determines, in step S110, that the read latency is not important or does not need to be improved, in step 112, the first CPU 210 of the host 200 may transfer a command including a set bit SB having a second value, e.g., a low level or logic 0, to the second CPU 314 of the data storage device 300 through the components 205, 220, 110, 312, and 311. According to at least one example embodiment of the inventive concepts, when the data storage device 300 is an eMMC, the command may be a SWITCH command CMD6, and the set bit SB may be included in the SWITCH command CMD6.

The memory interface 318 may store the set bit SB transferred from the host 200 in a register (not shown) according to a control of the second CPU 314 or the firmware FW implemented by the second CPU 314 (S114). When the data storage device 300 is an eMMC, the register may be an EXT_CSD register. For example, the EXT_CSD register may be a memory region of the second memory 330; however, the EXT_CSD is not limited thereto.

The first CPU 210 of the host 200 may generate a state check command SCC, and transfer the state check command SCC to the second CPU 314 of the data storage device 300 through the components 205, 220, 110, 312, and 311 (S116). When the data storage device 300 is an eMMC, the state check command SCC may be a CMD13.

Example descriptions of the eMMCs referred to in the present specification and definitions of the eMMC-related terms used in the present specification can be found in document JESD84-B50 (revision of JESD84-B451, June 2012), that is, Embedded Multi-Media Card (eMMC) Electrical Standard (5.0).

The second CPU 314 or the firmware FW implemented by the second CPU 314 may check or refer to a value of the set bit SB stored in a register, and check or determine an operational state of the data storage device 300 according to a result of checking the value of the set bit SB (S118).

The operational state determined in step S118 may be a state that indicates whether or not a background operation is being (or is about to be) performed by the data storage device 300, and the background operation may include garbage collection, wear leveling, and/or a read reclaim operation; however, the background operation is not limited to the examples discussed above. The read reclaim operation may include copying or transferring valid data in a memory block of a second memory region of the second memory 330 to one or more memory blocks of a first memory region of the second memory 330.

When a value of the set bit SB stored in a register is a first value, e.g., logic 1 (YES of S120), the second CPU 314 or the firmware FW implemented by the second CPU 314 may transfer a second response RES2 to the first CPU 210 through the components 311, 312, 110, 220, and 205 based on the operational state (e.g., the operational state determined in step S118) (S122). Here, the second response RES2 may include state information of the data storage device 300 and processing information on a write command for the data storage device 300. The processing information may include information indicating the operational state.

For example, when the data storage device 300 is an eMMC, the state information may be or include state values stored in an EXT_CSD register. The processing information may include information on latency of a write command to be processed in the data storage device 300 or information on a background operation (e.g., garbage collection, wear leveling, and/or read reclaim operation) which is being performed or will be performed in the data storage device 300.

That is, the processing information may include information that indicates a write operation (or time for performing a write operation) corresponding to a next write command will be longer (e.g., longer than a reference value set in accordance with the preferences of an operator or manufacturer of the data storage device 300), information that indicates a background operation is currently being performed in the data storage device 300, or information that indicates the background operation will be performed in the data storage device 300.

The input/output scheduler 214 which is running in the first CPU 210 may reschedule at least one of a read command and a write command to be transmitted to the data storage device 300 based on the second response RES2 or analyzing a result of the second response RES2 (S124). For example, the input/output scheduler 214 may change an issue sequence (or issue order) of original commands (for example, a read command and a write command) to be transmitted to the data storage device 300 based on the second response RES2 (S124). For example, the second response RES2 may include one or more bits corresponding to processing information. For example, one or more bits may be included in an EXT_CSD vendor specific field.

When the background operation, e.g., garbage collection, is performed in a plurality of steps, and the plurality of steps have different performance time, the processing information may include one or more bits which represent each of the plurality of steps. That is, the input/output scheduler 214 which is running in the first CPU 210 may reschedule or change at least one of a read command and a write command to be transferred to the data storage device 300 based on the second response RES2 including the processing information (S124).

When the input/output scheduler 214 transfers the read command or the write command which is rescheduled or changed based on the second response RES2 including the processing information to the device driver 216, the device driver 216 may transfer the read command or the write command transferred from the input/output scheduler 214 to the second CPU 314 through the components 205, 220, 110, 312, and 311 (S126).

In step S128, the second CPU 314 or the firmware executed by the second CPU 314 may control the memory interface 318 so as to perform the read command or the write command received through the components 205, 220, 110, 312, and 311.

When the device driver 216 transfers a read command in step S126, in step S128, the memory interface 318 may read data corresponding to the read command from the second memory 330 and the read data may be transferred to the host 200 through components 311, 312, and 110, while a read operation corresponding to the read command is performed.

Further, when the device driver 216 transfers a write command in step S126, in step S128, the memory interface 318 may write or program write data received through components 110, 312, and 311 in a memory region of the second memory 330 corresponding to an address included in the write command during a write operation corresponding to the write command.

When a value of the set bit SB stored in a register is a second value (e.g., logic 0) (No of S120), the second CPU 314 or the firmware FW executed by the second CPU 314 may transfer a first response RES1 to the first CPU 210 through the components 311, 312, 110, 220, and 205 (S130). Unlike the second response RES2, the first response RES1 may include only state information of the data storage device 300 (e.g., the first response RES1 may exclude the processing information discussed above with respect to the second response RES2). For example, when the data storage device 300 is the eMMC, the state information may be state values stored in the EXT_CSD register.

The input/output scheduler 214 may maintain an original schedule for the read command and the write command to be transferred to the data storage device 300 based on the first response RES1 (S132). That is, the input/output scheduler 214 does not change the issue sequence (or the issue order) of commands (e.g., a read command and a write command) to be transferred to the data storage device 300 based on the first response RES1 (S132).

When the input/output scheduler 214 transfers an original read command or write command to the device driver 216 based on the first response RES1, the device driver 216 may transfer the read command or the write command transferred from the input/output scheduler 214 to the second CPU 314 through the components 205, 220, 110, 312, and 311 (S134).

The second CPU 314 or the firmware FW executed by the second CPU 314 may control the memory interface 318 so as to perform the read command or the write command received through the components 205, 220, 110, 312, and 311.

During a read operation corresponding to the read command, the memory interface 318 may read data corresponding to the read command from the second memory 330, and the read data may be transferred to the host 200 through components 311, 312, and 110 (S136). During a write operation corresponding to the write command, the memory interface 318 may write the write data received through the components 110, 312, and 311 in a memory region of the second memory 330 corresponding to an address included in the write command (S136).

According to at least one example embodiment of the inventive concepts, when the result of step S120 is YES, steps S122-S128 are performed and steps S130-S136 are not performed; and when the result of step S120 is NO, steps S130-S136 are performed and steps S122-S128 are not performed.

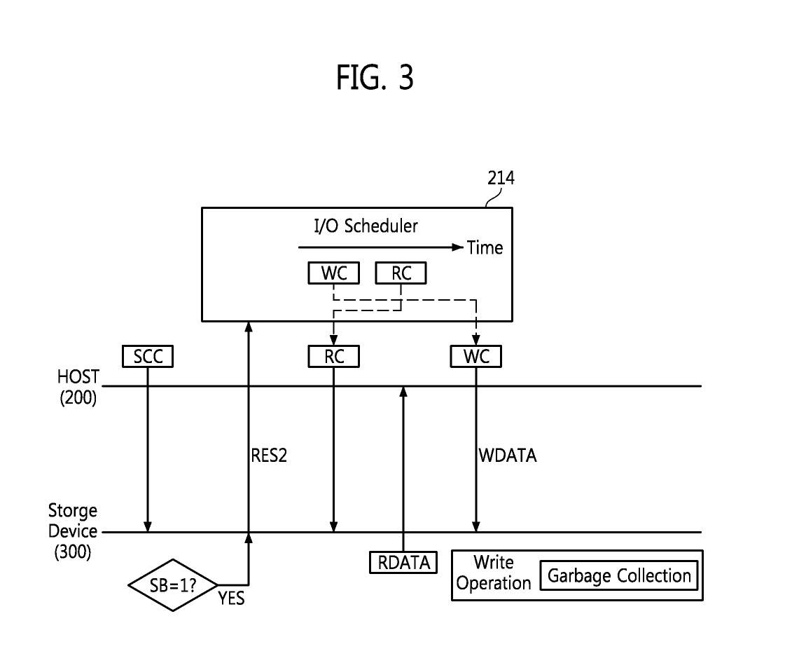

FIG. 3 is a drawing which describes an operation of the data processing system 100 shown in FIG. 1 according to at least one example embodiment of the inventive concepts. In the example illustrated in FIG. 3, it is assumed that the scheduler 214 is scheduled to issue a write command WC prior to a read command RC, and a set bit SB having a first value (e.g., a high level or logic 1) is set in a specific field of a register. As described above, the register in which the set bit SB is set may be an EXT_CSD register of the eMMC. Referring to FIGS. 1 to 3, the first CPU 210 may transfer a state check command SCC to the data storage device 300.

The second CPU 314 or the firmware FW executed by the second CPU 314 may interpret or decode the state check command SCC, and determine a value of the set bit SB stored in a register according to a result of the interpretation or decoding. Since the value of the set bit SB is a first value, the second CPU 314 or the firmware FW executed by the second CPU 314 may output the second response RES2 to the host 200.

The input/output scheduler 214 may perform determination as follows based on the second response RES2. That is, since a background operation (for example, garbage collection) needs to be performed in the data storage device 300 when a write operation corresponding to the write command WC is performed in the data storage device 300, the input/output scheduler 214 may determine that a response time for the write command WC will be extended or longer.

Accordingly, the input/output scheduler 214 may issue the read command RC to the device driver 216 prior to issuing the write command WC to the device driver 216 based on the second response RES2. For example, the input/output scheduler 214 may change the issue sequence of the write command WC and the read command RC, and issue or output the read command RC to the device driver 216 prior to issuing or outputting the write command WC to the device driver 216 so as to improve read performance or read response time,

The second CPU 314 may control the memory interface 318 in response to the read command RC output from the host 200. The memory interface 318 may read data RDATA corresponding to the read command RC from the second memory 330. The read data RDATA may be transferred to the host 200. When processing for the read command RC is completed, the input/output scheduler 214 may issue or output the write command WC to the device driver 216. The host 200 may transfer the write command WC and the write data WDATA to the data storage device 300 through the interface 110.

The second CPU 314 or the firmware FW executed by the second CPU 314 may control the memory interface 318 based on the write command WC. The memory interface 318 may write the write data WDATA in the second memory 330. The garbage collection may be performed while the write data WDATA is written in the second memory 330. For example, when a free block of the second memory 330 is insufficient while the write data WDATA is written in the second memory 330, the garbage collection may be performed.

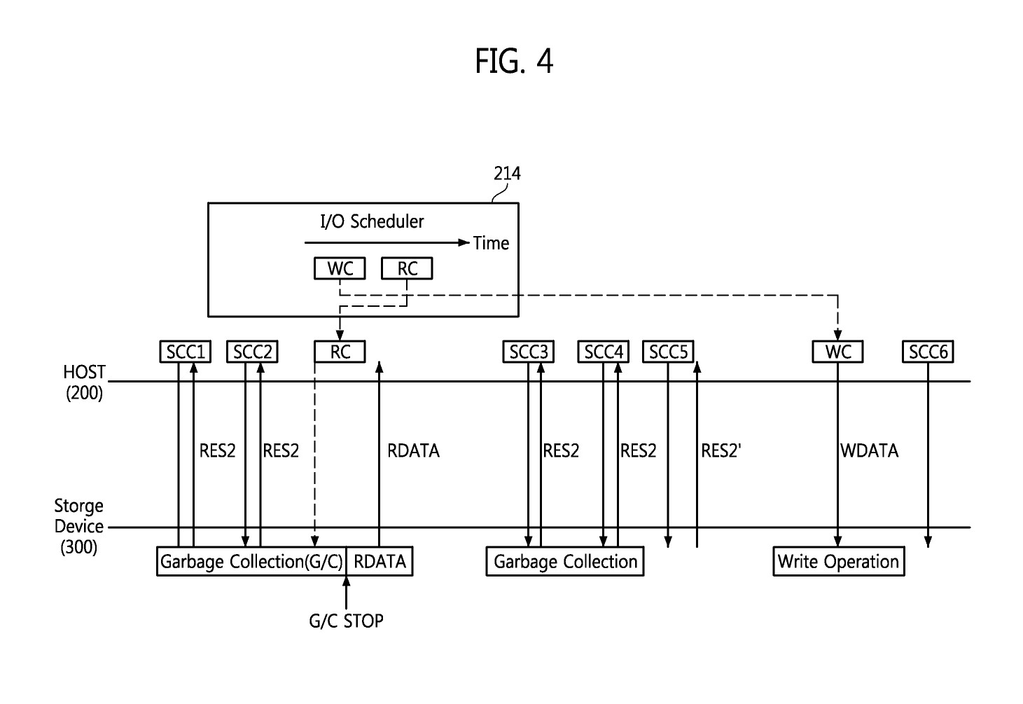

FIG. 4 is a drawing which describes the operation of the data processing system shown in FIG. 1 according to at least one example embodiment of the inventive concepts. When the garbage collection is being performed in the data storage device 300 while the garbage collection and a write operation are separated from each other or an auto background operation is being performed, the input/output scheduler 124 may issue only a read command without issuing a write command.

It is assumed that the scheduler 214 is scheduled to issue the write command WC prior to the read command RC, and the set bit SB having the first value is set in a register.

Referring to FIGS. 1, 2, and 4, while the garbage collection is being performed in the data storage device 300, the first CPU 210 of the host 200 may output a first state check command SCC1 to the data storage device 300. The data storage device 300 may transfer, to the host 200, a second response RES2 including processing information which indicates that the garbage collection is currently performed in the data storage device 300, in response to the first state check command SCC1.

While the garbage collection is continuously performed in the data storage device 300, the first CPU 210 of the host 200 may output a second state check command SCC2 to the data storage device 300. The data storage device 300 may transmit a second response RES2 including processing information which represents the garbage collection is currently performed in the data storage device 300 to the host 200 in response to the second state check command SCC2.

When a read operation is required in the data storage device 300, the first CPU 210 or the input/output scheduler 214 may change the issue order of a write command WC and a read command RC, and transmit the read command RC to the device driver 216 according to a changed issue order.

The second CPU 314 or the firmware FW executed by the second CPU 314 may control the memory interface 318 so as to stop the garbage collection based on the read command RC transmitted from the device driver 216. Accordingly, the garbage collection is stopped (G/C STOP).

The memory interface 318 may read data RDATA corresponding to the read command RC from the second memory 330 according to a control of the second CPU 314 or the firmware FW executed by the second CPU 314. The read data RDATA may be transmitted to the host 200. When a read operation for the data RDATA is completed according to the read command RC, the second CPU 314 or the firmware FW executed by the second CPU 314 may control the memory interface 318 so as to continue the garbage collection. Accordingly, the garbage collection is continued.

When the garbage collection is being performed in the data storage device 300, the first CPU 210 of the host 200 may output a third state check command SCC3 to the data storage device 300. The data storage device 300 may transmit, to the host 200, the second response RES2 including processing information which indicates that the garbage collection is currently being performed in the data storage device 300, in response to the third state check command SCC3.

When the garbage collection is continuously performed in the data storage device 300, the first CPU 210 of the host 200 may output a fourth state check command SCC4 to the data storage device 300. The data storage device 300 may transmit, to the host 200, the second response RES2 including processing information which represents the garbage collection is still being performed in the data storage device 300 in response to the fourth state check command SCC4.

After the garbage collection is completed in the data storage device 300, the first CPU 210 of the host 200 may output a fifth state check command SCC5 to the data storage device 300. The data storage device 300 may transmit to the host 200 a second response RES2′ including processing information which indicates that the garbage collection is not currently being performed in the data storage device 300, in response to the fifth state check command SCC5.

The first CPU 210 or the input/output scheduler 214 may issue a write command WC to the device driver 216 according to the changed issue order based on the second response RES2′. The host 200 may transmit write data WDATA corresponding to the write command WC to the data storage device 300 through the interface 110.

The second CPU 314 or the firmware FW may control the memory interface 318 in response to the write command WC. The memory interface 318 may perform a write operation of writing the write data WDATA in the second memory 330. After the write operation is completed, the first CPU 210 of the host 200 may output a sixth state check command SCC6 to the data storage device 300.

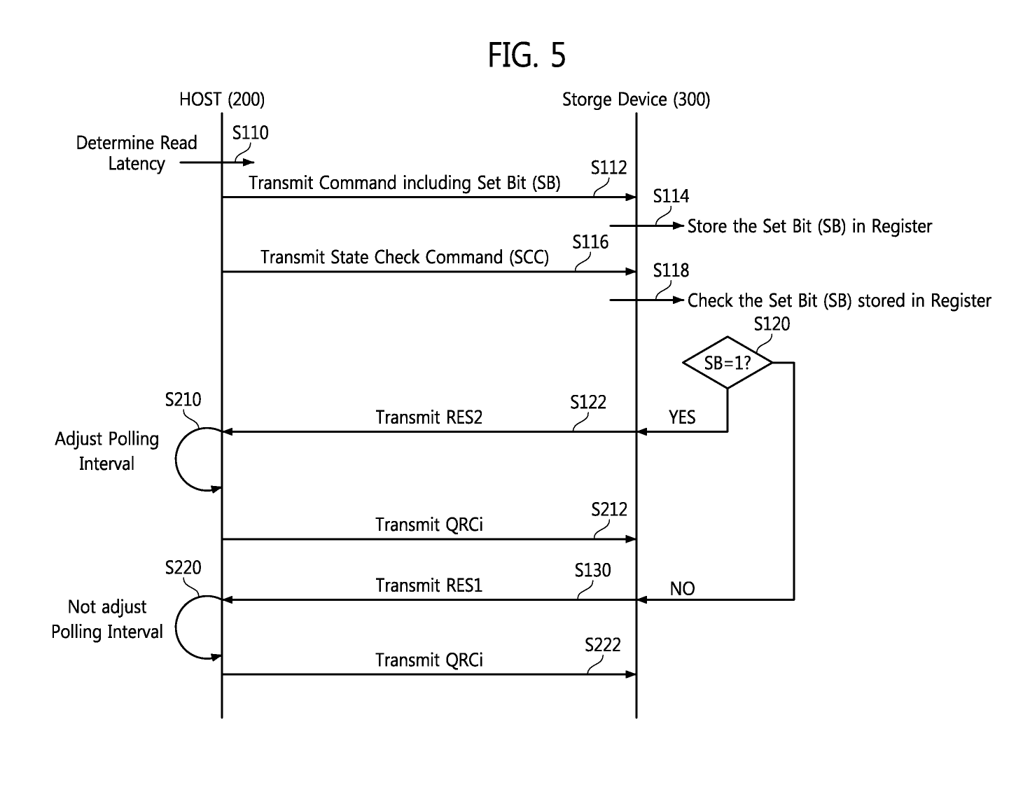

FIGS. 3 and 4 illustrate examples in which the data storage device 300 is used as a synchronous data storage device. FIG. 5 is a data flowchart which describes the operation of the data processing system shown in FIG. 1 according to at least one other example embodiment of the inventive concepts. For example, the data storage device 300 may be used as an asynchronous data storage device.

Referring to FIGS. 1, 2, and 5, the first CPU 210 may determine a read latency in step S110. Further, in step S110 the first CPU 210 may determine whether or not the read latency is important or needs to be improved. For example, in step S110 the first CPU 210 may determine a time point when read latency is determined to be important or a time point when read performance is determined to need improving. The determination may be performed by firmware implemented by the first CPU 210 or the input/output scheduler 214.

In step S112 the first CPU 210 transfers a command including a set bit SB based on the determination in step S110. When the first CPU 210 determines, in step S110, that the read latency is important or needs to be improved, in step S112, the first CPU 210 may transmit a command including a set bit SB having a first value, e.g., a high level or logic 1, to the second CPU 314. According to at least one example embodiment of the inventive concepts, in step S112, the first CPU 210 may transmit a command including a set bit SB having a first value, e.g., a high level or logic 1 to the second CPU 314 through the components 205, 220, 110, 312, and 311 (S112) only at the time point when read performance is determined to need improving. However, when the first CPU 210 determines, in step S110, that the read latency is not important or does not need to be improved, in step 112, the first CPU 210 may transmit a command including a set bit SB having a second value, e.g., a low level or logic 0, to the second CPU 314 through the components 205, 220, 110, 312, and 311.

The memory interface 318 may store the set bit SB having a first value or a second value in a register according to a control of the second CPU 314 or the firmware implemented by the second CPU 314 (S114). The first CPU 210 may transmit a state check command SCC to the data storage device 300 so as to determine an operational state of the data storage device 300 (S116).

The second CPU 314 or the firmware FW implemented by the second CPU 314 may check or determine a value of the set bit SB stored in a register embodied in the data storage device 300, and check or determine an operational state of the data storage device 300 in response to a state check command SCC (S118). As described above, the operational state may indicate whether or not a background operation is performed, and the background operation may include garbage collection, wear leveling, and/or a read reclaim operation; however, the background operation is not limited thereto.

When a value of the set bit SB stored in a register is a first value, e.g., logic 1 (YES of S120), the second CPU 314 or the firmware FW implemented by the second CPU 314 may transfer the second response RES2 to the first CPU 210 through the components 311, 312, 110, 220, and 205 based on the operational state (e.g., the operational state determined in step S118) (S122). The second response RES2 may include state information of the data storage device 300 and processing information on a write command for the data storage device 300.

The first CPU 210 or the input/output scheduler 214 may adjust a transmission interval or a polling interval of a queue ready check command for checking whether or not a queue is ready based on the second response RES2 (S210). When the transmission interval or the polling interval is increased, usage of the first CPU 210 is decreased. The first CPU 210 or the input/output scheduler 214 may transmit a queue ready check command QRCi to the data storage device 300 at adjusted transmission intervals or adjusted polling intervals (S212).

However, when a value of the set bit SB stored in a register is a second value, e.g., logic 0 (NO of S120), the second CPU 314 or the firmware FW may transmit the second response RES2 to the first CPU 210 through the components 311, 312, 110, 220, and 205 based on the operational state (S130). At this time, the second response RES2 may include only state information of the data storage device 300.

The first CPU 210 or the input/output scheduler 214 maintains the transmission interval or the polling interval of the queue ready check command for checking whether or not a queue is ready as it is (S220). The first CPU 210 or the input/output scheduler 214 may transmit the queue ready check command QRCi to the data storage device 300 at original transmission intervals or original polling intervals (S222).

According to at least one example embodiment of the inventive concepts, when the result of step S120 is YES, steps S122, S210, and S212 are performed and steps are not performed; and when the result of step S120 is NO, steps S130, S220, and S222 are performed and steps S122, S210, and S212 are not performed.

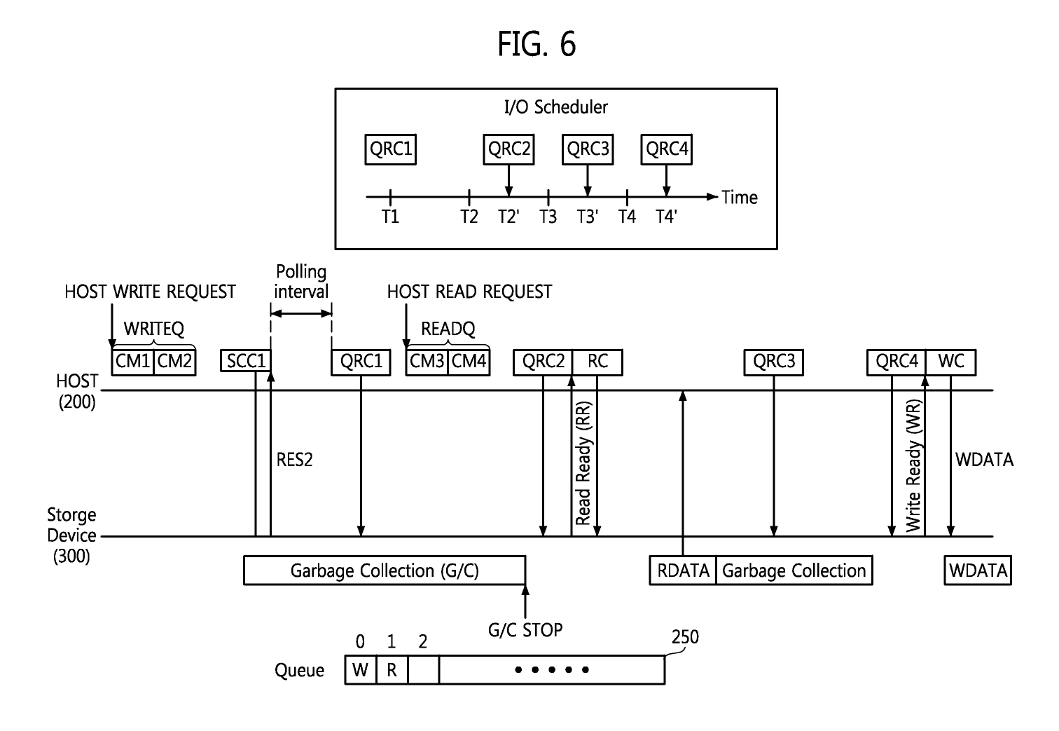

FIG. 6 is a conceptual diagram which describes a method of adjusting a transmission interval of a queue ready check command according to an at least one example embodiment of the inventive concepts. It is assumed that the scheduler 214 is initially scheduled to issue a queue ready check command at each time point T1, T2, T3, and T4, and the set bit SB having a first value is set in a register. At this time, it is assumed that intervals between two time points T1 and T2, T2 and T3, and T3 and T4 are the same as each other.

Referring to FIGS. 1, 5, and 6, it is assumed that a write queue command WRITEQ is generated according to a host write request HOST WRITE REQUEST generated in the first CPU 210, and the write queue command WRITEQ is generated according to commands CM1 and CM2, and is stored in a 0^{th} queue of a queue 250. While a background operation, e.g., garbage collection, is performed in the data storage device 300, the first CPU 210 may output a first state check command SCC1 to the data storage device 300.

The second CPU 314 or the firmware FW may transmit the second response RES2 including state information of the data storage device 300 and processing information which indicates that the garbage collection is currently being performed in the data storage device 300 to the host 200 in response to the first state check command SCC1. The first CPU 210 or the input/output scheduler 214 may transmit a first queue ready check command QRC1 to the data storage device 300 at a first time point T1.

Then, it is assumed that a read queue command READQ is generated according to a host read request HOST READ REQUEST generated in the first CPU 210, and the read queue command READQ is generated according to commands CM3 and CM4, and is stored in a “1^{st}” queue of the queue 250. It is assumed that “W” in the “0^{th}” queue position is a write operation, and “R” in the “1^{st}” queue position is a read operation.

The data storage device 300 stops the garbage collection G/C in response to the read queue command READQ (G/C STOP). The first CPU 210 or the input/output scheduler 214 may transmit a second queue ready check command QRC2 to the data storage device 3000 at an interval-adjusted second time point T2′. The second CPU 314 of the data storage device 300 or the firmware FW may transmit a read ready response RR to the host 200 in response to a second queue ready check command QRC2. Here, the read ready response RR may be a response for performing a read operation corresponding to the “1^{st}” queue member R.

The first CPU 210 or the input/output scheduler 214 may transmit a read command RC to the data storage device 300 based on the read ready response RR. The memory interface 318 of the data storage device 300 may read data RDATA stored in the second memory 330 according to a control of the second CPU 314 or the firmware operating according to the read command RC. The read data RDATA may be transmitted to the host 200.

After the read operation for the read command RC is completed or finished, the data storage device 300 may continue the garbage collection G/C. While the garbage collection G/C is performed, the first CPU 210 or the input/output scheduler 214 may transmit a third queue ready check command QRC3 to the data storage device 300 at an interval-adjusted third time point T3′.

After the garbage collection G/C is completed, the first CPU 210 or the input/output scheduler 214 may transmit a fourth queue ready check command QRC4 to the data storage device 300 at an interval-adjusted fourth time point T4′. The second CPU 314 of the data storage device 300 or the firmware FW may transmit a write ready response WR to the host 200 in response to the fourth queue ready check command QRC4. Here, the write ready response WR may be a response for performing a write operation corresponding to the “0^{th}” queue member W.

The first CPU 210 or the input/output scheduler 214 may transmit a write command WC and write data WDATA to the data storage device 300 based on the write ready response WR. The second CPU 314 of the data storage device 300 or the firmware FW may control the memory interface 318 according to the write command WC. The memory interface 318 may store the write data WDATA in the second memory 330.

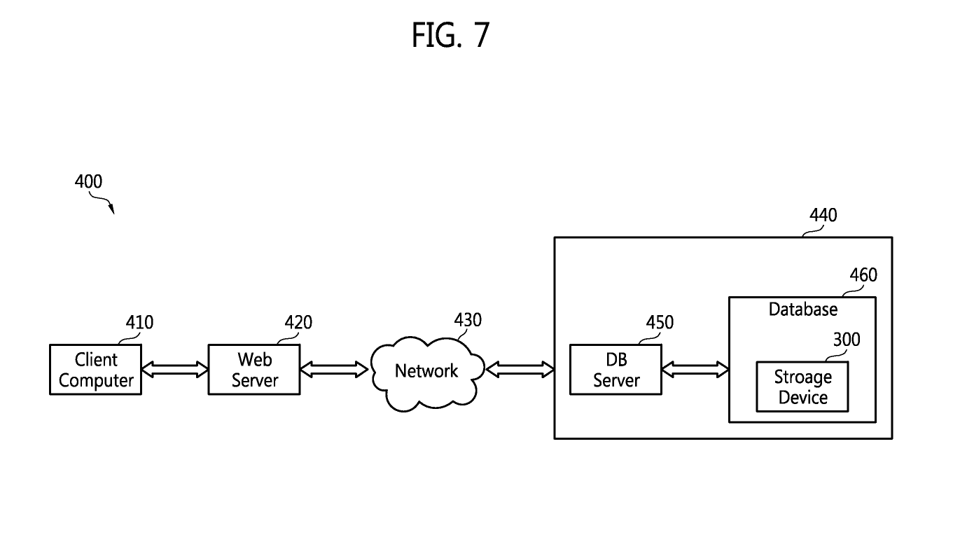

FIG. 7 is a block diagram of a system which includes the data processing system shown in FIG. 1. Referring to FIGS. 1 to 7, a system 400 may include at least one client computer 410, a server or web server 420, a network 430, and a data processing device 440. The data processing device 440 may include a database server 450 and a database 460. For example, the system 400 may be a search portal, a data center, or an internet data center (IDC).

The client computer 410 may communicate with the server 420 through a network. The client computer 410 may be embodied as a PC, a laptop computer, a smart phone, a tablet PC, a PDA, a MID, a wearable computer, an IoT device, or an IoE device. The server 420 may communicate with the database server 450 through the network 430. The database server 450 may perform a function of the host 200 of FIG. 1.

The database server 450 may control an operation of the database 460. The database server 450 may access at least one database 460. The at least one database 460 may include at least one data storage device 300. A structure and an operation of the at least one data storage device 300 may be substantially the same as or similar to the structure and the operation of the data storage device 300 described referring to FIGS. 1 to 6. The server 420 and the database server 450 may transmit data to, or receive data from, each other through the network 430. The network 430 may be a wired network, a wireless network, the internet, Wi-Fi, or a mobile phone network.

A host and a method for operating the host according to an at least one example embodiment of the inventive concepts may transmit a command requesting information indicating whether or not a background operation is performed to a data storage device so as to adaptively adjust read latency. A data storage device and a method for operating the storage device according to an at least one example embodiment of the inventive concepts may transmit a response which represents whether or not a background operation is performed to the host in response to the command requiring whether or not the background operation is performed transmitted from a host.

The host according to an at least one example embodiment of the inventive concepts may change an issue sequence (or an issue order) of commands transmitted to the data storage device so as to reduce read latency based on a response transmitted from a data storage device. The host according to an at least one example embodiment of the inventive concepts may adjust a transmission interval or a polling interval of a queue ready check command based on a response transmitted from the data storage device.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A method for operating a data storage device comprising:
receiving a first command including a set bit transmitted from a host;
storing the set bit in a register in response to the first command;
receiving a first state check command from the host; and
transmitting a response which includes state information of the data storage device and processing information corresponding to a write command for the data storage device to the host based on the first state check command and the set bit stored in the register.

2. The method of claim 1, further comprising:
generating, by the data storage device, the response such that the processing information includes information on latency of a write command to be processed in the data storage device.

3. The method of claim 1, further comprising:
generating, by the data storage device, the response such that the processing information includes information on garbage collection which is being performed in the data storage device.

4. The method of claim 3, further comprising:
receiving a read command from the host while the garbage collection is performed;
stopping the garbage collection in response to the read command;
transmitting read data to the host in response to the read command; and
resuming the stopped garbage collection.

5. The method of claim 3, further comprising:
transmitting a response which indicates a completion of the garbage collection to the host in response to a second state check command transmitted from the host after the garbage collection is completed; and
receiving a write command and write data from the host and storing the write data in a memory based on the write command.

6. The method of claim 3, wherein, when the garbage collection is performed in a plurality of steps, and the plurality of steps have different execution times, the data storage device generates the response such that the response includes the processing information including bits corresponding to each of the plurality of steps.

7. The method of claim 1, wherein the data storage device is an embedded multimedia card (eMMC), the first command is a SWITCH command (CMD6) including the set bit, the register is an EXT_CSD register, the storing the set bit includes storing the set bit in a vender specific field of the EXT_CSD register, and the first state check command is CMD13.

8. The method of claim 1, where the data storage device is a three-dimensional non-volatile memory device.

9. The method of claim 1, where the data storage device includes a three dimensional memory array, wherein the three-dimensional memory array comprises a non-volatile memory that is monolithically formed in one or more physical levels of memory cells having active areas disposed above a silicon substrate.

10. A method for operating a mobile computing device including a host and a data storage device, the method comprising:
determining, by the host, read latency of a read command to be performed in the data storage device;
transmitting, by the host, a first command to the data storage device according to a result of the determination, the first command including a set bit;
storing, by the data storage device, the set bit in a register in response to the first command;
transmitting, by the host, a first state check command to the data storage device; and
transmitting, by the data storage device, one of a first response and a second response to the host based on the first state check command and the set bit stored in the register.

11. The method of claim 10, further comprising:
generating the first response such that the first response includes state information of the data storage device, and
generating the second response such that the second response includes the state information of the data storage device and processing information corresponding to a write command for the data storage device.

12. The method of claim 11, further comprising:
rescheduling, by the host, at least one of a read command and a write command to be transmitted to the data storage device based on the second response.

13. The method of claim 11, further comprising:
adjusting, by the host, a transmission interval of a queue ready check command to be transmitted to the data storage device based on the second response.

14. The method of claim 11, further comprising:
generating the processing information such that the processing information includes at least one of information on latency of a next write command to be processed in the data storage device and information indicating a background operation which is being performed in the data storage device.

15. The method of claim 14, wherein the background operation includes at least one of garbage collection, wear leveling, and a read reclaim operation.

16. The method of claim 15, further comprising:
receiving, by the data storage device, a first read command from the host while the garbage collection is being performed;
stopping, by the data storage device, the garbage collection in response to the first read command;
transmitting, by the data storage device, read data to the host in response to the first read command; and
resuming, by the data storage device, the stopped garbage collection.

17. The method of claim 15, further comprising:
transmitting, by the data storage device to the host, a third response which indicates a completion of the garbage collection, in response to a second state check command,
the second state check command being a command transmitted from the host after the garbage collection is completed; and
receiving, by the data storage device, a first write command and write data from the host, and storing the write data in a memory based on the first write command.

18. The method of claim 10, wherein the data storage device is an embedded multimedia card (eMMC), the first command is a SWITCH command (CMD6) including the set bit, the register is an EXT_CSD register, the storing the set bit includes storing the set bit in a vender specific field of the EXT_CSD register, and the first state check command is CMD13.

19. A method for operating a host comprising:
determining, at the host, a read latency of a data storage device;
generating, at the host, a set indicator such that a value of the set indicator is selected by the host based on the determined read latency;
transmitting a state check command from the host to the data storage device;
receiving, at the host, a first response from the data storage device, a response type of the first response being a first type or a second type;
when the first response indicates that the data storage device is performing a background operation,
determining whether or not to rearrange an order of data access commands in a command schedule of the host based on the response type of the first response; and
sending a first data access command from the host to the data storage device based on the command schedule.

20. The method of claim 19 wherein, the determining whether or not to rearrange the order data access commands includes,
when the response type of the first response is the second type, rearranging the order of the data access commands in a command schedule of the host such that a read command in the command schedule is moved in front of a write command in the command schedule, and
when the response type of the first response is the first type, maintaining a current order of the command schedule without rearranging the command schedule.

21. The method of claim 19 wherein, the generating the set indicator includes generating the set indicator to have a first value when the determined latency is above a reference value and generating the set indicator to have a second value when the determined latency is not above the reference value.

22. The method of claim 20 wherein, the receiving the first response from the data storage device includes receiving the first response having the second response type when the set indicator has the first value and receiving the first response having the first response type when the set indicator has the second value.
